(19) United States
(12) Patent Application Publication
(10) Pub. No.: US 2002/0035664 A1
(43) Pub. Date: Mar. 21, 2002

(54) NATIVE IMAGE DATA STORAGE ON A VIRTUAL TAPE STORAGE SYSTEM

(76) Inventors: NEVILLE YATES, LOS GATOS, CA (US); JEFFREY MILLER, MENLO PARK, CA (US)

Correspondence Address: CHARLES E KRUEGER, TOWNSEND & TOWNSEND & CREW, TWO EMBARCADERO CENTER, 8TH FLOOR, SAN FRANCISCO, CA, 941113834

(21) Appl. No.: 09/111,475

(22) Filed: Jul. 8, 1998

Related U.S. Application Data
(60) Provisional application No. 60/052,018, filed on Jul. 9, 1997.

(51) Int. Cl. G06F 3/00; G11B 5/02; G06F 12/00; G06F 12/14

(52) U.S. Cl. 711/111; 360/55; 360/8

(57) ABSTRACT

An improved virtual tape storage device that can store an image of a virtual tape volume either as a stacked image or as a native image that is essentially indistinguishable from the image that would have been written had the host written the volume directly to the tape.

### CROSS-REFERENCES TO RELATED APPLICATIONS

This application claims the benefit of Provisional Application Ser. No. 60/052,018, filed Jul. 9, 1997, which is incorporated herein by reference for all purposes.

### BACKGROUND OF THE INVENTION

The present invention relates to storage systems, and in particular, to a method and apparatus for storing data on a virtual tape storage system.

A virtual tape storage system is a hardware and software product configured to interact with a host computer. Application programs running on the host computer store data output as tape volumes for storage. These tape volumes are stored in the virtual tape storage system as virtual volumes on virtual tape drives (VTD). A virtual volume is a collection of data, organized to appear as a normal tape volume, residing in the virtual tape storage system. To the host computer and to the application programs, the tape volume contents appear to be stored on a physical tape device of a particular model, with the properties and behavior of that model emulated by the actions of the virtual tape storage system. However, the data may actually be stored as a virtual volume on any of a variety of different storage mediums such as disk, tape, or other non-volatile storage media, or combinations of the above. The virtual volume may be spread out over multiple locations, and copies or “images” of the virtual volume may be stored on more than one kind of physical device, e.g., on tape and on disk.

When an image of the virtual volume is stored on disk, different portions of the volume's contents may be stored on different disk drives and on different, non-contiguous areas of each of the disk drives. The virtual tape storage system maintains indexes which allow the contents of any virtual volume whose image is stored on disk to be read by the host, the virtual tape storage system retrieving scattered parts as needed to return them in correct sequence.

When an image of a virtual volume is stored on tape, it may be stored on a single tape together with images of other virtual volumes, or different parts of the image may be stored on more than one different tape with each part again placed with images, or parts of images, of other virtual volumes. In both of these approaches to tape storage of virtual volume images, the images are said to be “stacked.” The virtual volume images may be stored on a variety of different tape device models other than the one being emulated. As with images stored on disk, the virtual tape storage system maintains indexes which allow it to retrieve the contents of any virtual volume stored in a stacked image from the tape or tapes on which it is stored.

A shortcoming of storing stacked images on tape arises because the stacked image is not recognizable by standard hardware and application programs. For example, many legacy backup and restore applications expect the tape volume to be stored in a particular format on the tape, and if it is not in that format, the application cannot read the tape volume. These applications are typically used to backup critical system data on tape. The tapes are stored at a location that is physically separate from the host computer, so in the case of a fire or other extraordinary event that causes the storage in the system to be lost, the system can be recreated from the backup tape. Since existing virtual tape devices store data using a stacked image, existing applications cannot read data that has been stored on the tapes.

Similarly, if a tape is made using existing virtual tape system, the tape cannot be transferred to another tape unit and read by a host that is connected to it. Again, this is because the stacked image is unreadable by a tape unit of the emulated variety in the absence of the virtual tape system.

Thus, an improved virtual tape system and methods for its operation that overcomes the shortcomings of the presently available devices is needed.

### SUMMARY OF THE INVENTION

The present invention provides an improved virtual tape system that has an option to store a virtual volume image as a “native image” that is essentially indistinguishable from the image that would have been written had the host written the volume directly to the tape with a conventional tape drive. A method of operation for such a virtual tape system is also provided.

In an embodiment of the present invention, the virtual tape system adopts the same format for storing data onto a tape drive attached to the virtual tape system as the host believes it is writing to the emulated tape device. The data is organized within the virtual tape system according to the same format as it will be written out to the tape drive. In a further embodiment, the data may be compressed in the virtual tape system according to the compression scheme used by the emulated tape device. The organized data is stored on the tape subsystem under the control of the virtual tape system, without additional metadata that may be present in the virtual tape system.

The storing of the native image by the virtual tape system is done transparently to the attached host or hosts. Also, the storing is performed by the virtual tape system without any significant performance penalty due to the decompressing and formatting of data, since the data is internally stored in the same format as it is intended to be stored on the tape in the tape drive. Thus, the data that is stored on the tape can be read subsequently by a host application that is coupled to a tape unit of the same type as the emulated tape device.

Other features and advantages of the invention will be apparent in view of the following detailed description and appended drawings.

### BRIEF DESCRIPTION OF THE DRAWINGS

FIG. 1A is a conceptual block diagram of a preferred embodiment of the invention;

FIG. 1B is a block diagram of a preferred embodiment of a tape device emulating (TDE) system according to the present invention;

FIG. 2 is a representation of a packet;

FIG. 3A is a more detailed representation of the packet of FIG. 2 using compressed data;

FIG. 3B is a more detailed representation of the packet of FIG. 2 using uncompressed user data;

FIG. 4 is a representation of a superblock; and

FIG. 5 is a representation of a superblock structure.

### DETAILED DESCRIPTION OF THE PREFERRED EMBODIMENTS

A preferred embodiment will now be described with reference to the figures, where like or similar elements are designated with the same reference numerals throughout the several views.

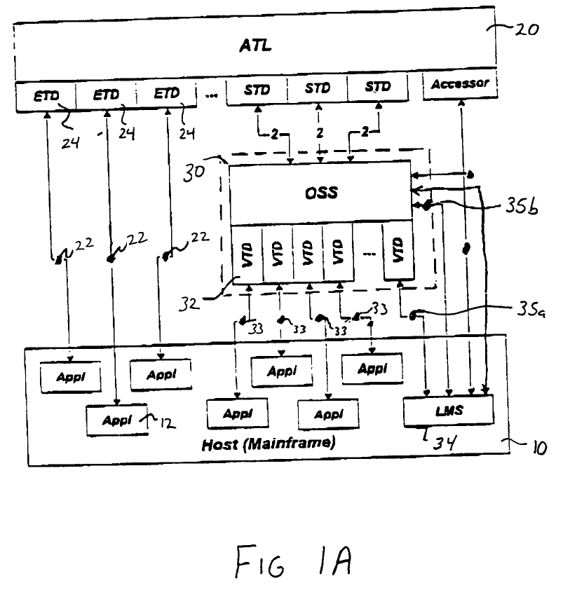

FIG. 1A is a high-level block diagram of a digital system in which a preferred embodiment of a virtual tape storage system of the present invention is utilized. In FIG. 1A, a host computer 10, for example an IBM mainframe computer, executes a plurality of applications 12. In practice, host computer 10 typically runs the MVS operating system manufactured by IBM, although other operating systems are well known to one of skill in the art and may also be used. MVS provides I/O services to various applications 12 including I/O for a tape unit 20, which may be an automatic tape library (ATL), or other type of tape storage device. Applications 12 may be coupled directly to tape unit 20 through ESCON tape devices (ETD) 24 by means of a physical interface such as an ESCON 3490 Magnetic Tape Subsystem Interface 22. MVS, the ESCON interface 22, and the host computer 10 are well-known in the art.

Applications 12 may also be coupled to tape unit 20 through a virtual tape controller 30, also referred to herein as an open system server (OSS). OSS is manufactured by the assignee of the present invention. Virtual tape controller 30 maintains virtual tape drives 32 (VTDs), which emulate the physical ETDs 24. More details of the VTDs 32 will be presented below. The interface between an application 12 and a VTD 32 is OSS Emulated Device interface 33, which in the preferred embodiment is an ESCON interface.

A library management system (LMS) software module 34 also resides on host 10 and provides services to MVS and virtual tape controller 30. LMS 34 is responsible for management of the tape library environment and performs such tasks as fetching and loading cartridges into drives, returning unloaded cartridges to their home locations, etc. The interface between LMS 34 and virtual tape controller 30 is the Library Manager Interface with paths 35a and 35b based on two different and distinct protocols.

VTD 32 is a non-physical device that responds as if it were a physical device. In the currently described embodiment, the emulated physical device is an IBM-3490 tape drive, although other devices may also be emulated. VTD 32 responds to commands issued on a channel in the same fashion as the emulated technology. Thus, the absence of a physical device may be unknown to application 12.

Applications 12 typically store data in tape volumes. Tape volumes are well-known data structures. A “virtual volume” is a collection of data and metadata that, taken together, emulate a real tape volume. When “mounted” on a VTD, these virtual volumes are indistinguishable from real tape volumes by the host computer. In this context, “data” refers to data output by the host to be stored on tape and “metadata” refers to information generated by virtual tape controller 30 which permits the emulation of real tape drives and volumes.

FIG. 1B is a high level block diagram of a part of virtual tape controller 30 utilizing an embodiment of the present invention that may be coupled to one or more host computers 10 (FIG. 1A). Host computers 10 are typically large mainframe computers running an operating system such as MVS, and various application programs.

A plurality of channel interfaces (CIFs) 42 are coupled to host I/O channels (not shown) to transfer data between host 10 and virtual tape controller 30.

Each CIF 42 includes a host interface 44, an embedded controller 46, a data formatter 48 for performing data compression and other functions, a buffer memory 50, an SBUS interface 52, and an internal bus 54. In the preferred embodiment, the embedded processor 46 is a model i960 processor manufactured by Intel Corporation.

A main controller 60 is coupled to CIFs 42 and includes a main processor 62, a main memory 64, an SBUS interface 66, and an internal bus 68. In the preferred embodiment, the main processor is a SPARC computer manufactured by Sun Microsystems, Incorporated. CIFs 42 and main controller 60 are coupled together by a system bus 70, which is an SBUS in the preferred embodiment.

Virtual tape controller 30 stores host data in virtual volumes mounted on VTDs 32. In one preferred embodiment, the data is originally stored on staging disks 80. Because virtual tape controller 30 must interact with the host as if the data were actually stored on physical tape drives, a data structure called a virtual tape drive descriptor is maintained in main memory 64 for each VTD 32. The virtual tape drive descriptor contains information about the state of the associated VTD 32. Additional structures, including a virtual tape “volume” structure and other structures subordinate to it, register the locations at which data is physically stored, among other information.

Subsequently, data may be transferred from staging disks 80 to one or more magnetic tape units 20. As mentioned above, tape units 20 may be individual tape units, automatic tape libraries (ATLs), or other tape storage systems. However, the location and other properties of the data is still defined in terms of the virtual tape volume structures in memory and stored in a disk-based control data set.

An example will help clarify the meaning of the terms. If application 12 intends to write data to tape, it requests that a tape be mounted on a tape drive. LMS intercepts the request and causes a virtual volume to be mounted on one of the VTDs 32 to receive the application output, which is delivered by the ordinary tape output programs of the MVS operating system. Blocks of data received by virtual tape controller 30 are “packetized”, the packets are grouped together in clusters with a fixed maximum size, called “extents”, and the extents are written to staging disks 80 in virtual tape controller 30. Often the extents containing data from one virtual tape are scattered over several disk drives. All information about the packetization, such as packet grouping in extents and extent storage locations, required to reassemble the volume for later use by the host is metadata. Part of the metadata is stored with each extent and part is stored on non-volatile storage in virtual tape controller 30, separate from the extent storage.

According to the present invention, instead of storing the virtual volume on tape unit 20 as a “stacked” volume as described above, the virtual volume image may alternatively be stored by itself, occupying a tape exclusively. In this alternative arrangement, the virtual tape storage system emulates the characteristics of the physical tape drive being used, and the format with which the virtual volume image is stored on the tape is identical to the format it would have had if host 10 had originally written the volume contents directly to a conventional tape drive of that model. In such a case, the image that is stored on the tape unit 20 is said to be a “native” image.

In a native image, the volume serial number of the tape used to store the native image is identical to the volume serial number of the virtual volume. An image of a virtual volume stored as a native image can be read by host 10 directly if the tape on which it is stored is removed from the virtual tape storage system or from its control and loaded on a tape drive of the emulated model attached directly to the host. So, referring to FIG. 1 for example, application 12 could read a tape stored by virtual tape controller 30 from ETD 24 through ESCON interface 22.

Tape volumes that are critical to the operation of an enterprise in the event of a disaster typically must be stored on a tape drive in native image format to be restored by commonly available backup and restore applications. If the virtual tape storage system should suffer catastrophic failure, native image tapes can be used to allow the host computer 10 access to the critical data through an ordinary tape drive, for example a stand-alone tape drive. Similarly, native image is useful for the interchange of data between and within an enterprise using a tape as the medium of exchange.

A tape containing a native image of a virtual volume can be placed in a secure, perhaps fireproof storage area or even placed in an area far removed from the building housing the host computer. Then, in case of disastrous loss of the use of the computer and its associated equipment, or loss of access to the building housing them, as through fire, flood, or power loss, the critical data can be made available to any substitute host equipped with ordinary tape drives. Further, a tape containing a native image of a virtual volume can be removed from the virtual tape storage system and read by any host equipped with real tape drives of the emulated model. This provides a method of exporting virtual volumes to allow their contents to be shared with other computer systems.

An image of a virtual volume is a complete copy of the data, but it may be stored in a proprietary format which optimizes the volumetric efficiency of the data storage. In particular, the data may be compressed during its transmission from the host 10 into the virtual tape storage system and kept in compressed form during its residency in the storage system. In the compressed form, the data can be moved more rapidly to and from memories and storage devices within the storage system and can be stored in less space, raising the effective capacity of storage devices including disks as well as tapes.

Storing the data of a virtual tape volume by writing it to a tape drive in a compressed form does not normally produce a native image of the volume, because when a host reads data back from a tape so written, the data will still be compressed, hence not usable by the host. Decompressing the data before writing to a tape could conceivably produce a native image, but at the serious cost of time-consuming decompression processes, either in software or in special, expensive hardware added for the purpose. It also taxes the bandwidth of bus paths over which data is moved during the decompression process and during transmission to the tape drive.

According to the present invention, images of virtual volumes may be stored on tapes in native format without incurring the penalties of decompression. The method relies on the adoption, for storing all data blocks output by a host to a virtual tape drive of the virtual tape storage system, of a format which matches precisely the format used internally by actual tape drives of the models being emulated. This format is used whether the data blocks are to be stored on disks, on tapes, or on other media. An example of such a format is found in the American National Standard ANSI X3.2241994, “Extended magnetic Tape Format for Information Interchange (18-Track, Parallel, 12.65 mm (0.50 in), 1491 cpmm (37 871 cpi), Group-Coded Recording)”, which is incorporated herein by reference in its entirety for all purposes. However, other formats may also be preferably used.

Under this standard, and in similar modern tape formatting standards, data blocks are compressed, for example in accordance with American National Standard ANSI X3.2251994, “Compaction Algorithm—Binary Arithmetic Coding,” which is also incorporated herein by reference in its entirety for all purposes.

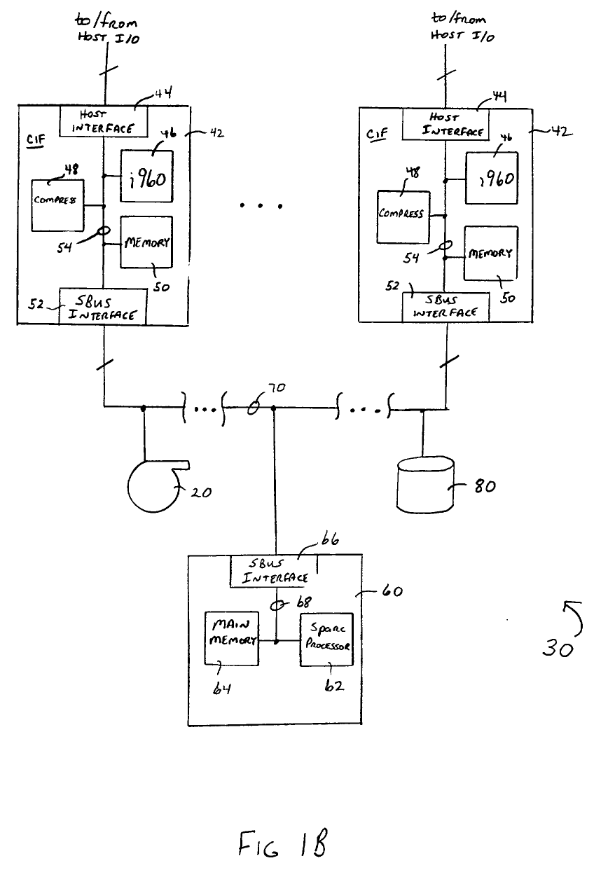

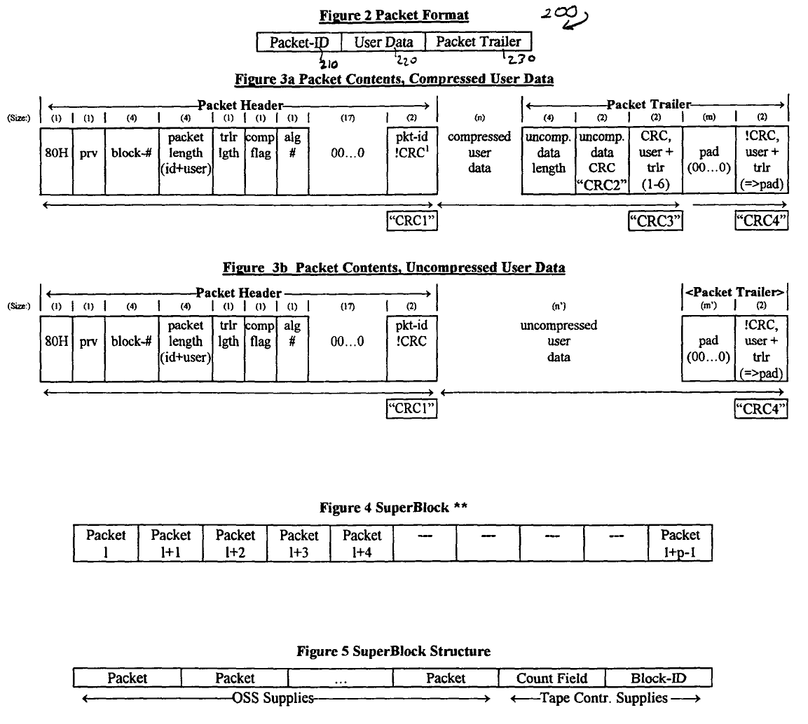

Formatting a data block under this method produces a 37 packet” 200 as shown in FIG. 2. Packet 200 has a header 210 that includes, for example, a Packet-Id, user-data 220, and a trailer 230. Packet 200 is shown in more detail in FIGS. 3A and 3B. Packet 200, for the example of the cited ANSI standard, contains a version of the hosts data block, compressed or, optionally not compressed, and descriptive control information such as the sequential number of the block in the sequence of all blocks written to a virtual tape volume, the lengths of the block, before and after compression, flags signaling whether compression was used and which of allowable compression algorithms was used, and calculated “CRC” check characters useful for verifying that packet 200, when transmitted from one storage system component to another, survived without corruption. In other words, the parts of packet 200 make the formatted block substantially self-describing.

When packets comprising an image of a virtual tape volume are stored on disks or as a stacked image on tapes, they are accompanied by records of metadata describing the virtual volume affiliation of any co-located group of stored packets and specifying where, in the sequence of the packets, tape or file “marks” were requested by the host to be inserted in the stream to mark certain boundaries of block groups for the later convenience of the host in positioning within the sequence.

In a physical tape drive conforming to the cited ANSI standard or a similar one, when blocks are written by a host to which the drive is attached directly or through a tape controller, the formatter part of the tape drive or controller electronics converts the blocks to packets 200 and groups packets 200 together, in the order of their receipt from the host, into “superblocks” for writing to the physical tape. This aggregating of packets into superblocks provides the advantage that fewer space-wasting gaps will be left between the physical records on a tape. Gaps are used in a subsequent reading process to allow reading to begin at any stored record and achieve clocking synchronization. FIG. 4 shows the aggregation of packets into superblocks. FIG. 5 shows the aggregate with a six-byte control information field appended for use in checking that subsequent reading yields the desired number and total length of packets.

In the present invention, tape drives and tape controllers attaching to the virtual tape storage system to allow virtual volume images to be stored on tapes have been slightly modified to accept from virtual tape controller 30, in executing single write commands according to a modified command code protocol, superblock groupings of pre-formatted packets, only checking that the CRC characters are valid and, in one embodiment, appending the six-byte control values supplied under a separate preparatory command. The preformatted superblocks so received are encoded according to the tape drive's Recorded-Block format, inserting synchronizing and error detection and correction patterns, and are written to the tape just as though they had been formed from host output blocks by compressing, packetizing, and aggregating inside the tape drive or controller.

During subsequent reading of the tapes, the tape drives return entire superblocks, just as they were received during writing, if commanded to do so, using commands adapted according to the command code modification protocol. However, if commanded to read using unmodified command codes, the drives will return an individual data block for each read command, extracted from one packet, decompressed and restored to the data block form originally output by the host when the virtual volume was written.

To produce a native-image copy of a virtual tape volume, the virtual tape storage system writes the contents of just one virtual volume, without adding any metadata records descriptive of the volume, by aggregating groups of packets according to conventions which limit the sizes of superblocks (see, for example, ANSI X3.224-1994). Using the metadata records in a volume image from which the native image is being copied, for example a disk-resident volume image, virtual tape controller 30 records actual tape marks by means of suitable commands to the tape drives at the points in the packet sequence where the host originally requested their insertion. If the native image tape is subsequently read by the original host or some other host computer, using an ordinary, unmodified, tape drive of an emulated model, the data blocks read will be identical to, and in the same sequence as, those originally output by the host which wrote the data to a virtual tape drive of the virtual tape storage system.

While the above is a complete description of specific embodiments of the invention, various modifications, alternative constructions, and equivalents may be used. Therefore, the above description should not be taken as limiting the scope of the invention as defined by the claims.

What is claimed is:

1. A virtual tape storage system coupled to a host computer, the virtual tape storage system responding to commands from the host computer as an emulated tape unit, the emulated tape unit having an expected format for storing data, the virtual tape storage system comprising:
a processor for organizing data in the virtual tape storage system according to the emulated format; and
a tape unit for storing data on tape coupled to the processor, wherein data in the emulated format may be stored on the tape by the tape unit.

2. The virtual tape storage system of claim 1 wherein a compression unit in the tape unit is disabled when the data in the emulated format is stored on the tape.

3. The virtual tape storage system of claim 2 wherein the virtual tape storage system disables the compression unit with a command code.

4. The virtual tape storage system of claim 1 wherein the tape storing the data in the emulated format may be read by a host application coupled to a physical tape unit of the type of the emulated tape unit.

5. The virtual tape storage system of claim 1 further comprising a disk unit, the disk unit storing the data in the emulated format.

6. The virtual tape storage system of claim 5 further comprising a compression unit for compressing the data from the host computer according to the compression used by the emulated tape unit.

7. The virtual tape storage system of claim 5 wherein the organized data may be transferred from the virtual storage system to the tape without intervention from the host computer.

8. A method of storing data on a tape using a virtual tape storage system according to a format expected by a host application, the method comprising the steps of:
organizing the data in the virtual tape storage system according to the expected format; and
transferring the data in the expected format to a tape unit for storage on the tape.

9. The method of claim 8 further comprising the step of compressing the data.

10. The method of claim 9 wherein the compressing step is done in the virtual tape storage system.

11. The method of claim 9 wherein the compressing step is done according to a compression algorithm used by the tape drive for data coming directly from the host.

12. The method of claim 8 wherein the compression step is done according to the ANSI X3.225-1994 standard.

13. The method of claim 8 wherein the format is the ANSI X3.224-1994 standard.

14. The method of claim 8 further comprising the step of describing the data with metadata in the virtual tape storage system.

15. The method of claim 14 wherein the metadata includes bits describing whether the data is compressed.

16. The method of claim 14 wherein the metadata is not transferred to the tape unit.

17. The method of claim 8 wherein the organizing step organizes the data into a plurality of packets and a control field describing the plurality of packets.
